(19) United States
(12) Patent Application Publication
(10) Pub. No.: US 2005/0192828 A1
(43) Pub. Date: Sep. 1, 2005

(54) Method of viewing images of remains and photos together with video backgrounds and audio on television and the internet

(75) Inventors: Hermann Knippscheer, Baldwin, NY (US); Daniel D. Richard, Ocean Ridge, FL (US)

Correspondence Address: NICOLE KUZMIN-NICHOLS, 3650 SPECTRUM BOULEVARD, UTC II, SUITE 170, TAMPA, FL, 33612, US

(73) Assignee: in memoriam inc.

(21) Appl. No.: 10/975,964

(22) Filed: Oct. 28, 2004

Related U.S. Application Data
(60) Provisional application No. 60/548,015, filed on Feb. 27, 2004.

(51) Int. Cl. G06F 17/60

(52) U.S. Cl. 705/1

(57) ABSTRACT

The subject invention pertains to method of viewing the remains of a deceased individual organism in conjunction with selected visual and auditory stimulus to provide special emotional comfort to family members and friend (“survivors”) by allowing them to view the remains at a time and place convenient to the survivor. The time of remembrance to take place directly in a survivor's home or at any place of their choice, i.e. vacation place, office, etc and at their convenience, irrespective of the distance the survivor is from the actual physical location of the remains, the time of day, and the weather. This remote viewing of the remains eliminates traveling altogether, which is especially advantageous for very busy, or elderly and handicapped people.

### CROSS-REFERENCE TO RELATED APPLICATION

The present application claims the benefit of priority of U.S. Provisional Application Ser. No. 60/548,015, filed Feb. 27, 2004, which is hereby incorporated by reference herein in its entirety, including any figures, tables, or drawings.

### BACKGROUND OF THE INVENTION

This application is an improvement of U.S. Pat. No. 6,604,018 issued Aug. 5, 2003 which relied for priority purposes on U.S. Provisional Application No. 60/235,811 filed Sep. 27, 2000, all of which are incorporated herein by reference in their entirety. This invention serves the purpose of providing special emotional comfort to family members and friends (“survivor” or “patron”) of a deceased human or animal by allowing them to view the remains at a time and place convenient to the survivor. This invention would allow the time of remembrance to take place directly in a survivor's home or at any place of their choice, i.e. vacation place, office, etc and at their convenience. Final disposition of a body after death can include i) burial or entombment of the body in a cemetery; ii) cremation of the body followed by disposition of the remains by burial, scattering of the remains, placement in a columbarium, or retention by family; and iii) donation of the body to medical science. In cases where the body or remains are buried, entombed, or placed in a columbarium, the survivor still must travel to the location where the remains or body reside, this invention eliminates traveling altogether, which is especially advantageous for very busy, or elderly and handicapped people.

### BRIEF SUMMARY OF THE INVENTION

This invention is intended to provide special emotional comfort to those individuals who survive a deceased human or animal. This invention would allow the

### BRIEF SUMMARY OF THE INVENTION

This invention is intended to provide special emotional comfort to those individuals who survive a deceased human or animal. This invention would allow the time of remembrance to take place directly in a survivor's home or at any place of their choice, i.e. vacation place, office, etc and at their convenience, regardless of time of day, weather, or location. This invention provides a less costly means of disposition and may prevent scattering of cremated remains.

### BRIEF DESCRIPTION OF DRAWINGS

FIG. 1 is a schematic plan view illustrating the functional elements of one embodiment of the present invention.

### DETAILED DISCLOSURE OF THE INVENTION

Final disposition of a body after death can include (i) burial or entombment of the body; (ii) cremation of the body followed by disposition of the remains by burial, scattering of the remains, placement in a columbarium, or retention by family; and (iii) donation of the body to medical science, with cremation following. In any of these cases, there might just be a memorial stone in some far away cemetery as a reminder of the location where the deceased was laid to rest. Currently unless survivors have decided to retain their deceased cremated remains in their possession, survivors must travel to a cemetery, mausoleum, or a cremation repository facility in order to mentally connect with the deceased. In addition for cremated remains, if several survivors exist unless the remains are divided between all the survivors so that each individual retains some of the remains in their possession, some survivors must still travel to the location of the individual with the remains in their possession. However, due to lack of time and/or transportation, due to age and/or health related reasons, people cannot or do not want to travel to far-away cemeteries. In spite of that, every human being wishes to be remembered long after death, and would feel comforted by knowing that there is a means of extending and enhancing the memory in the hearts and minds of their relatives and friends. This present invention eliminates traveling altogether, which is especially advantageous for very busy, or elderly and handicapped people.

By the deceased, it is meant an entity such as a human or animal, to which the survivor has an interest in mentally and/or visually connecting with after death of the deceased.

By remains, it is meant the cremated remains of the deceased housed in a urn or vessel; the gravesite, marker, or headstone at which the deceased's body or the cremated remains of the deceased was buried; the mausoleum or columbarium at which the deceased's body or the cremated remains of the deceased was entombed; or the Garden of Remembrance or similarly named location for the scattering of cremated remains.

By visually connecting, it is meant to see the urn or vessel; the gravesite, marker, or headstone at which the deceased's body or the cremated remains of the deceased was buried; the mausoleum or columbarium at which the deceased's body or the cremated remains of the deceased was entombed; or the Garden of Remembrance or similarly named location for the scattering of cremated remains.

By patron, it is meant an individual who has an established identity account allowing the individual or the individual's designee access to one or more sets of remains. A patron can be the deceased who had established an identity account prior to death and has designated another individual to preserve their identity account.

Establishment of an identity account by a patron may include receiving or creating an assigned personal identification code and/or password which are entered into a computer by the patron via a keyboard or other interface device. Identification of the patron can be as simple as entering a personal identification code and/or password intro a keyboard or keypad, which then automatically searches a computer database to identify the remains which the patron has proper access to view. Alternative identification methodologies include magnetic codes and bar codes which may be imprinted on identification cards, tags, rings, etc.

Payment for services rendered for each identity account can be via (i) one-time all inclusive fee, (ii) installment plan, (iii) payment at time services are rendered, or (iv) other arrangement. Additionally, the identity account can be linked to a credit or debit card which identifies the holder of the credit or debit card as having proper access to one or more sets of remains but also facilitates payment by the patron for the services provided. A credit or debit card account of any individual patron may be charged in installments, for instance, monthly, independently of actual viewings. Alternatively or additionally, a charge may be made to the patron's account every time the patron views the remains. Moreover, ancillary services that are provided may bear respective additional charges. The charges may be made to the accounts of respective patrons at the time of requesting or utilizing the basic and ancillary services or thereafter, for example, at the end of the month. Fees for the storage of the cremated remains may be waived if patron participates in an installment plan for the viewing of the remains.

With the present invention, patrons do not need to leave the comfort of their homes to mentally and/or visually connect with the deceased. They can, at any time, request to have access to viewing the remains via Internet, television, cable, satellite TV, or the telephone. The remains will then be displayed on their TV screen, computer monitor, or telephone screen with a visual and audible background of their choice. Alternative methods of viewing the remains via different electronic devices may be incorporated as additional technology is developed in those areas.

The following examples are provided to illustrate or exemplify certain preferred embodiments of the present invention illustrative of the present invention but are not intended in any way to limit the present invention

### EXAMPLE 1

In a preferred embodiment, the images of remains can be viewed on the Internet by a patron by (i) establishment of an identity account of a patron, (ii) receiving from patron the cremated remains of the deceased for deposit and storage into a cremation repository as described in U.S. Pat. No. 6,604,018, (iii) receiving from a patron identification of the patron and identification of the remains patron requests viewing of, (iv) operating a database to verify patron is entitled to view the requested remains, (v) operating a transport system to transport the remains to a predetermined setting where cameras take high-definition (HD) images of the remains in the setting, (vi) transmitting live images of the remains in the setting utilizing Internet web browsers to home computers or laptops or by broadcasting stations and then transmitting via satellite or cable to home TVs, and (vii) returning the unaltered remains to their storage location after the viewing is complete.

### EXAMPLE 2

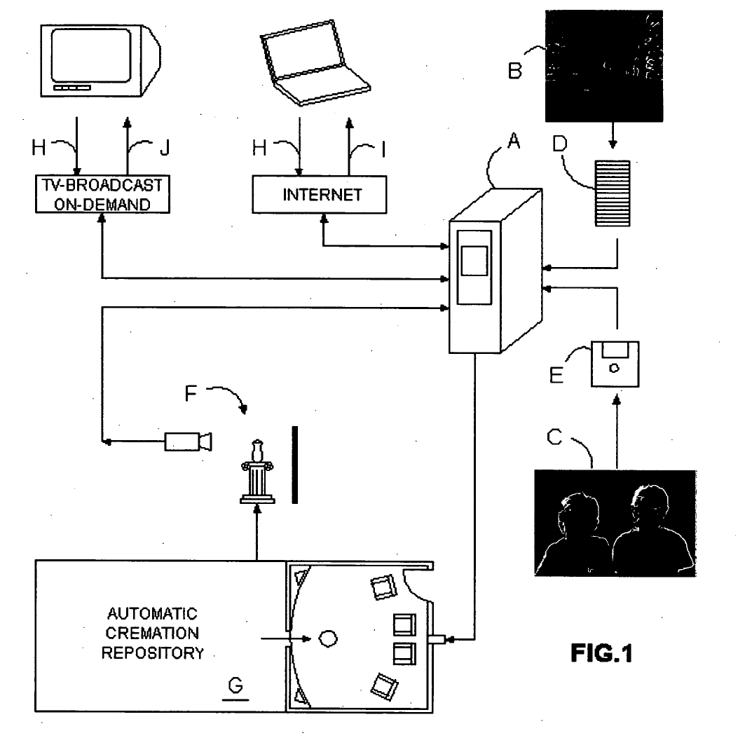

In a preferred embodiment, the live images created from Example 1 can be combined with a plurality of environmental conditions (FIG. 1 B-E). These environmental conditions refer primarily to the senses of sight and sound. Various combinations of the environmental conditions can be selected by the patron based on predefined preferences or momentary reminiscence. Databanks (FIG. 1D) or forms of media storage, such as computer disks (FIG. 1E), CDs, or DVDs, can hold visual imagery such as (i) personal images, such as photos (FIG. 1C) (still images) or videos (moving images—with or without audio) of the deceased singly or with others provided by the patron and (ii) a selection of prerecorded generic video images (FIG. 1B) (still or moving), such as: various scenes religious symbols (multiple-branch candlestick holders, crosses, cross-legged sitting figures, many arm figures, etc.), architectural and historical sites (churches, temples, synagogues, sacred walls, pre-historic monuments, etc.) and nature scenes (rainforest, ocean shore, mountain woods, waterfall, etc.). Databanks or forms of media storage, such as computer disks, CDs, or DVDs, can hold auditory stimulus such as a selection of prerecorded audio (classical music, sounds of nature, contemporary music, religious readings [Bible, Torah, Koran, etc.], poetry readings, messages from the deceased, etc.). At the time of a requested viewing of the remains together with preferred environmental conditions, patron would select the environmental conditions requested. The images of the remains would be superimposed onto the image of a selected environmental condition selected from the databanks. These combined images are then transmitted utilizing Internet web browsers to home computers or laptops or by broadcasting stations and then transmitting via satellite or cable to home TVs along with the requested auditory condition.

### EXAMPLE 3

In a preferred embodiment, the images of remains can be viewed on the Internet by a patron by (i) establishment of an identity account of a patron, (ii) receiving from patron the cremated remains of the deceased for deposit and storage into a cremation repository as described in U.S. Pat. No. 6,604,018, (iii) preparing images of the remains prior to storage, such as using a camera to take high-definition (HD) images (FIG. 1F), these images are then stored in databank (FIG. 1A), (iv) placing the unaltered remains in their storage location after the images are taken (FIG. 1G), (v) receiving from a patron identification of the patron and identification of the remains patron requests viewing of (FIG. 1H), (vi) operating a database to verify patron is entitled to view the requested remains, and (vii) transmitting the stored images of the remains utilizing Internet web browsers to home computers or laptops (FIG. 1I) or by broadcasting stations and then transmitting via satellite or cable to home TVs (FIG. 1J) along with any requested environmental conditions, as outlined in Example 2 (FIG. 1B-E), without the need for removing the remains from their storage location. Thousands of people would have simultaneous access to all urns stored and/or video clips or digital high-definition images stored at any time of the day and 365 days a year.

### EXAMPLE 4

In a preferred embodiment and a modification of Example 1, a plurality of independently operating robots or other mechanical device with video capabilities, such as a camera to take high-definition (HD) images, located at cemeteries, columbariums, or crematories that are computer controlled access the location of remains of the deceased (gravesite, tomb, memorial stone, etc.). The robots can be self-propelled machines capable of traveling over various terrain (grass, gravel, pavement, etc.) to a set of predetermined coordinates designating the location of the remains of the deceased. Cameras take high-definition (HD) images of the remains in its natural setting and transmit live images of the remains utilizing Internet web browsers to home computers or laptops or by broadcasting stations and then transmitting via satellite or cable to home TVs.

### EXAMPLE 5

In a preferred embodiment, patrons who wish to retain the cremated remains of the deceased in their home, scatter the remains at sea, etc. could provide personal images, such as photos (still images) or videos (moving images—with or without audio) of the deceased singly or with others that would be stored in databanks and could be combined with any requested environmental conditions, as outlined in Example 2 and transmitted utilizing Internet web browsers to home computers or laptops or by broadcasting stations and then transmitting via satellite or cable to home TVs without the need for the remains.

### EXAMPLE 6

In a preferred embodiment, a plurality of independent photographers with video capabilities, such as a camera to take high-definition (HD) images of the location of the remains of the deceased (gravesite, tomb, memorial stone, etc.). High-definition (HD) images of the remains in its natural setting are then stored in databank. These images could be combined with any requested environmental conditions, as outlined in Example 2 and transmitted utilizing Internet web browsers to home computers or laptops or by broadcasting stations and then transmitting via satellite or cable to home TVs without the need for the remains.

### EXAMPLE 7

In a preferred embodiment, the video clips and still images created from Examples 1-6 can also be hosted and superimposed by the cable and broadband communication providers and/or other program and the Internet service providers.

### EXAMPLE 8

In a preferred embodiment, the video clips and still images created from Examples 1-6 can be used to create media carriers, such as DVDs or VHS tapes, that could be made available to patrons.

Specifically, this invention would be available to the general public who would like to be remembered after death by their friends and family members and who would like to provide this special comfort to them.

The invention has been described in an illustrative manner, and it is to be understood the terminology used is intended to be in the nature of description rather than of limitation. Obviously, many modifications and variations of the present invention are possible in light of the above teachings and one of ordinary skill in the art, in light of this teaching, can generate additional embodiments and modifications without departing from the spirit of or exceeding the scope of the claimed invention. Therefore, it is to be understood that within the scope of the appended claims, the invention may be practiced otherwise than as specifically described. Accordingly, it is to be understood that the drawings and descriptions herein are proffered by way of example to facilitate comprehension of the invention and should not be construed to limit the scope thereof.

1. A method for remote viewing of the remains of the deceased, comprising the transmitting of images of the remains
(i) utilizing Internet web browsers to home computers, laptops, or video capable device; or
(ii) by broadcasting stations and then transmitting via satellite or cable to home televisions.

2. A method set forth in claim 1, further comprising: transmitting images of the remains together with the patron's selection of requested environmental conditions.

3. A method set forth in claim 2 wherein the environmental conditions comprise visual imagery.

4. A method set forth in claim 2 wherein the environmental conditions comprise auditory stimulus.

5. A method set forth in claim 2 wherein the environmental conditions comprise both visual imagery and auditory stimulus.

6. A method for remote viewing of the remains of the deceased, comprising
(i) establishment of an identity account of a patron; and
(ii) receiving from patron the cremated remains of the deceased for deposit and storage into a cremation repository; and
(iii) receiving from patron identification of the patron and identification of the remains patron requests viewing of; and
(iv) operating a computer and database to verify patron is entitled to view the requested remains; and
(v) transmitting images of the remains in the setting, with or without patron defined environmental conditions, utilizing Internet web browsers to home computers, laptops, or video capable device or by broadcasting stations and then transmitting via satellite or cable to home televisions.

7. A method set forth in claim 6, further comprising: transmitting images of the remains together with the patron's selection of requested environmental conditions.

8. A method set forth in claim 6, further comprising the operating of said computer includes the means for extracting or confirming payment from identity accounts of patrons.

9. A method for remote viewing of the remains of the deceased, comprising
(i) establishment of an identity account of a patron; and
(ii) receiving from patron the cremated remains of the deceased for deposit and storage into a cremation repository; and
(iii) receiving from patron personal images, such as photos (still images) or videos (moving images—with or without audio) of the deceased singly or with others; and
(iv) receiving from patron identification of the patron and identification of the remains patron requests viewing of; and
(v) operating a computer and database to verify patron is entitled to view the requested remains; and
(vi) transmitting images of the remains in the setting, with or without patron defined environmental conditions, utilizing Internet web browsers to home computers, laptops, or video capable device or by broadcasting stations and then transmitting via satellite or cable to home televisions.

10. A method set forth in claim 9, further comprising: transmitting images of the remains together with the patron's selection of requested environmental conditions.

11. A method set forth in claim 9, further comprising the operating of said computer includes the means for extracting or confirming payment from identity accounts of patrons.

12. A method for remote viewing of images of the deceased, comprising
(i) establishment of an identity account of a patron; and
(ii) receiving from patron personal images, such as photos (still images) or videos (moving images—with or without audio) of the deceased singly or with others; and
(iii) receiving from patron identification of the patron and identification of the deceased patron requests viewing of; and
(iv) operating a computer and database to verify patron is entitled to view the requested deceased; and
(v) transmitting images of the deceased, with or without patron defined environmental conditions, utilizing Internet web browsers to home computers, laptops, or video capable device or by broadcasting stations and then transmitting via satellite or cable to home televisions.

13. A method set forth in claim 12, further comprising: transmitting images of the deceased together with the patron's selection of requested environmental conditions.

14. A method set forth in claim 12, further comprising the operating of said computer includes the means for extracting or confirming payment from identity accounts of patrons.

15. A method of payment, comprising elimination of storage fees for patrons who pay viewing fees in periodic installment intervals.

16. A method for viewing of images of the deceased, comprising
(i) establishment of an identity account of a patron; and
(ii) receiving from patron personal images, such as photos (still images) or videos (moving images—with or without audio) of the deceased singly or with others; and
(iii) receiving from patron identification of the patron and identification of the deceased patron requests viewing of; and
(iv) operating a computer and database to verify patron is entitled to view the requested deceased; and
(v) creating media carriers, such as digital video discs or video tapes, with images of the deceased, with or without patron defined environmental conditions, and then delivering said media carriers to the patron.
